(19) United States
(12) Patent Application Publication
(10) Pub. No.: US 2012/0173588 A1
(43) Pub. Date: Jul. 5, 2012

(54) ONLINE ESTATE DOCUMENT MANAGEMENT SYSTEM

(76) Inventors: Howard Gene Rotter, Arcadia, CA (US); Charles Murray Rotter, Arcadia, CA (US)

(21) Appl. No.: 12/983,769

(22) Filed: Jan. 3, 2011

(51) Int. Cl. G06F 17/30

(52) U.S. Cl. 707/802; 707/E17.005

(57) ABSTRACT

A system and method for an online estate document management, the system comprising a user interface; one or more than one estate document servers operably connected to the user interface; an estate document database operably connected to the one or more than one estate document servers; instructions for verifying the user; instructions for version control of the one or more than one estate document; and instructions for notifying one or more than one recipient of changes to the one or more than one estate document.

### FIELD

The present invention relates to document management for estate planning, more particularly to an online estate document management system to prevent unauthorized changes in stored estate documents using easily producible audit trails and timely notifications to all affected parties when changes are made to the stored estate documents.

### BACKGROUND

Estate planning involves wills, trusts, beneficiary designations, powers of appointment, property ownership (joint tenancy with rights of survivorship, tenancy in common, tenancy by the entirety), gifts, living wills, prenuptial agreements, marital agreements, durable powers of attorney, medical powers of attorney, and general powers of attorney for an individual, couple or a family. All of these documents must be maintained for individuals to ensure that their desires for the distribution of their property and assets are followed. However, there are many examples of both famous and infamous cases where the individual's desires were unknown or disputed through long litigations, probate and familial infighting. These problems occur when there is no verifiable way for the courts to determine what the person desires for passing the estate.

For example, a will or testament is a legal declaration by which a person, a testator, names one or more persons to manage the estate and provides for the transfer of the testators property at death. A will may also create a testamentary trust that is effective only after the death of the testator.

When a will is created, one or more copies are made. Sometimes the copies are left with one or more attorneys, relatives, or friends. As time goes on, alternate wills can be created as circumstances change or codicils may be added, changed, or removed. Unscrupulous holders of wills can alter them with modern scanning and retouching techniques to create fraudulent versions or deceive an incompetent testator to sign a fraudulent version. At the testator's death, there can be a dispute over which copy of the will is the valid one. Holders of wills which favor them are likely to assert that theirs is the valid and final version and others either predate theirs or are fraudulent. This has historically led to expensive legal disputes with the courts having to sort through various amounts of evidence in order to determine how best to resolve the wishes of the deceased depleting estate assets and often causing rifts among the survivors.

There have been many attempts at solving this problem as this chart adapted from Wikipedia shows.

| Software | Platforms supported |
|---|---|
| AccuRev [6] | Any Java Platform (Unix-like, |
| | Windows, Mac OS X) |
| Bazaar[7] | Unix-like, Windows, Mac OS X |
| BitKeeper[8] | Unix-like, Windows, Mac OS X |
| ClearCase[9] | Linux, Windows, AIX, Solaris, |
| | HP UX, i5/OS, OS/390, z/OS, |
| Code Co-op[10] | Windows |
| Codeville[11] | Unix-like, Windows, Mac OS X |
| CVS[12] | Unix-like, Windows, Mac OS X |
| CVSNT[14] | Unix-like, Windows, Mac OS X, i5/OS |
| darcs[16] | Unix-like, Windows, Mac OS X |
| Fossil[17] | POSIX, Windows, Mac OS X, Other |
| Git[18] | POSIX, Windows, Mac OS X |
| GNU arch[19] | Unix-like, Windows, Mac OS X |
| IC Manage[20] | Unix-like, Windows, Mac OS X |
| LibreSource | Unix-like, Windows, Mac OS X |
| Synchronizer[21] | |
| Mercurial[23] | Unix-like, Windows, Mac OS X |
| MKSF[24] | Unix-like, Windows |
| Monotone[25] | Unix-like, Windows, Mac OS X |
| Perforce[26] | Unix-like, Windows, Mac OS X |
| Rational Team | Linux, Windows, AIX, Solaris, |
| Concert[28] | HP UX, i5/OS, OS/390, z/OS, |
| StarTeam[29] | Windows and Cross-platform via |
| | Java based client |
| Subversion (SVN)[30] | Unix-like, Windows, Mac OS X |
| SVKF[32] | Unix-like, Windows, Mac OS X |
| Team Foundation | Server: Windows Server 2003; |
| Server[34] | Clients: Windows and Web included |
| Synergy[35] | Linux, Windows, Unix-like |
| Vault[37] | Unix-like, Linux, Windows |
| Visual SourceSafe[39] | Windows |

For example, version control software companies have audit and notification functions, but these products have not been used in the creation of estate documents, while Websites such as LegalZoom.com and Buildawill.com, enable the creation of estate documents.

Disadvantageously, however, none of the products list have an audit trail associated with the creation of an online estate document, such as, for example, a will. Further, there is no method to track the exact date and time of different versions of estate documents. Nor does any of the prior art have a notification function to let the executor or other interested parties know that a new version of an estate document has been created or that an existing estate document has been modified.

Therefore there is a need for an estate document management system that overcomes the limitations of the prior art.

### SUMMARY OF THE INVENTION

A system for online estate document management comprising: a user interface; one or more than one estate document servers operably connected to the user interface; an estate document database operably connected to the one or more than one estate document servers; instructions for verifying the user; instructions for version control of the one or more than one estate document; and instructions for notifying one or more than one recipient of changes to the one or more than one estate document. The user interface comprises instructions for entering estate documents, creating estate documents or both creating and entering estate documents. The database comprises the current version of the estate document(s) and every previous version of estate document(s). The estate document servers further comprise instructions for encrypting the estate documents.

There is also provided a method for using the online estate document management comprising the steps of: a) providing the system of claim 1; b) transmitting account information is transmitted to a user; c) confirming the security identification; d) transmitting the latest version of one or more than one estate document to the user; e) receiving the one or more than one estate document from the user; f) verifying the one or more than one estate document for completeness and security; g) modifying the one or more than one estate document by adding the security identification, a time and date stamp, and other estate document indicia to the one or more than one estate document; h) storing the modified version of the one or more than one estate document the database without destroying any previous versions of the one or more than one estate documents; and i) sending notifications of the change to the one or more than one estate document to designated recipients. Additionally, the method further comprises storing a first version of the estate document in the database. Also, the method further comprises transmitting complete audit trails, sent notifications, and the estate document versions upon receipt of a request from an authorized user of the account. Finally, the method further comprises the steps for initially creating an account comprising: a) transmitting an account creation form upon request from a user; b) receiving account information by the estate document server; c) processing the account information; d) transmitting a security identification from the estate document server to the user for future access to the system.

### BRIEF DESCRIPTION OF THE DRAWINGS

These and other features, aspects and advantages of the present invention will become better understood with regard to the following description, appended claims, and accompanying figures where:

FIG. 1 is a diagram of an online estate document management system to prevent unauthorized changes in stored estate documents using easily producible audit trails and timely notifications to all affected parties when changes are made to the stored estate documents according to one embodiment of the present invention; and

FIG. 2 is a flowchart of a method of an online estate document management system to prevent unauthorized changes in stored estate documents using easily producible audit trails and timely notifications to all affected parties when changes are made to the stored estate documents according to one embodiment.

### DETAILED DESCRIPTION

The present invention overcomes the limitations of the prior art by combining three technologies, online will creation, with version control software, with email and text messaging in order to overcome these problems. The present invention provides an online estate document management system to prevent unauthorized changes in stored estate documents using easily producible audit trails and timely notifications to all affected parties when changes are made to the stored estate documents.

Using the present invention allows a user to control and track changes to estate documents, such as, for example, a will, via online security and tracking tools. The present invention also prevents unauthorized changes and reduces the possibility of forgery and unauthorized versions through an easily producible audit trail and timely notification to all affected parties when authorized changes are made to the estate document(s). If the maker of the estate document “opts out” of using the system they must, through the system, give notice to all affected parties or the change will be presumed due to undo influence.

The advantage of the present invention over the prior art lies in the audit trail and notifications functions. With all changes time stamped in a secure environment, the various versions of the one or more than one estate document can be compared to external events, such as dates of marriages or even health records if there is a dispute over competency. Optionally, notification functions can notify designated recipients, such as, for example, an executor, heirs or other individuals chosen to be involved in the process could avoid later disputes by keeping the process transparent. Notification may also serve to flag and identify unauthorized access or changes to the one or more than one estate document.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

The following description is provided to enable any person skilled in the art to make and use the invention and sets forth the best modes contemplated by the inventor, but does not limit the variations available.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s), data or both instruction(s) and data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “estate document” refers to, but is not limited to, estate planning documents, such as wills, trusts, beneficiary designations, powers of appointment, property ownership (joint tenancy with rights of survivorship, tenancy in common, tenancy by the entirety), gifts, living wills, prenuptial agreements, marital agreements, durable powers of attorney, medical powers of attorney, and general powers of attorney for an individual, couple or a family.

Various embodiments provide a method for an online document management system to prevent unauthorized changes in stored documents using easily producible audit trails and timely notifications to all affected parties when changes are made to the stored documents.

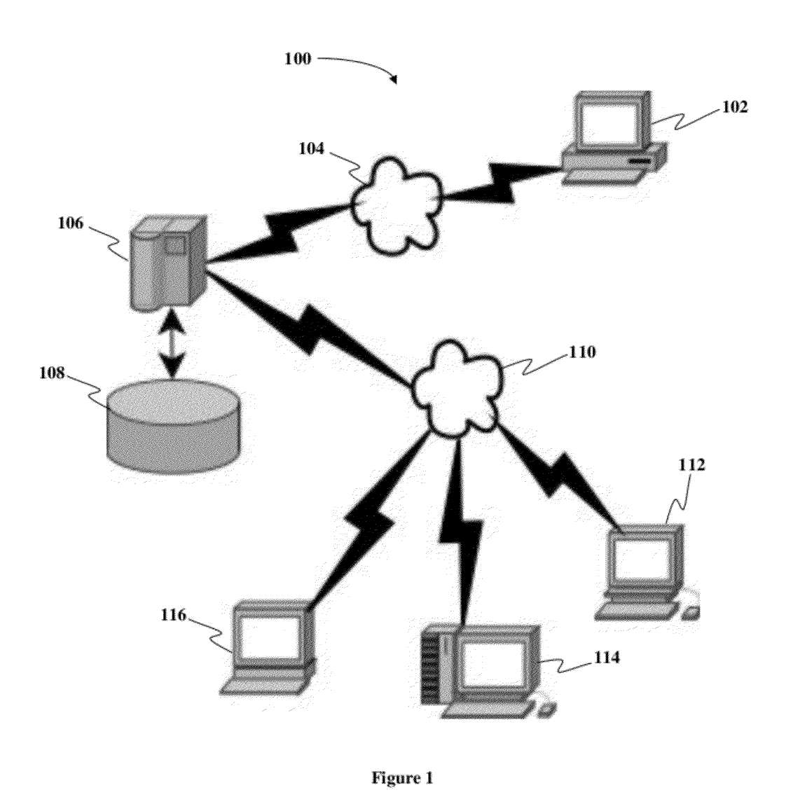

Referring now to FIG. 1, there is shown a diagram of an online document management system 100 to prevent unauthorized changes in stored documents using easily producible audit trails and timely notifications to all affected parties when changes are made to the stored documents according to one embodiment of the present invention. The system 100 comprises a computerized user interface 102 for entering one or more than one estate document 104 or creating one or more than one estate document 104 or both creating and entering one or more than one estate document 104. The user interface 102 is operably connected to one or more than one document server 106 for storing the one or more than one estate document 104 in a document database 108. The database 108 comprises the current version of the one or more than one estate document 104 and all previous versions of the same estate document 104. The one or more than one document server 106 comprises instructions for authenticating the one or more than one estate document 104, creating one or more than one estate document 104, controlling the version of the one or more than one estate document 104, and reporting 110 modifications of the one or more than one estate document 104 to relevant users 112, 114 and 116.

The system 100 transmits notifications to the relevant users 112-116 by standard notification services including, but not limited to, SMS (text messages), email, facsimile and another other type of notification that will be understood by those with skill in the art with reference to this disclosure.

The system 100 also comprises version tracking and control software for each of the one or more than one estate document. The system 100 provides estate document forms that can be presented to a user to be completed an received by the estate document server 106 and stored in the database 108 along with the version control information, time stamp, authentication requirements, security, and notification recipients that transform the standard estate document into a secure, auditable and traceable estate document unlike the prior art. Optionally, a central legal authorization can be added to the stored one or more than one estate document so that a court or law enforcement can have access to the one or more estate document. Notifications of this activity can be automatically sent to the designated recipients or, upon received instructions from the author of the estate document, be withheld from the notification recipients.

Also, the estate document server 106 comprises reporting functions that can transmit audit records that can be displayed to an authorized entity. The authorization can be accomplished using current technology, such as, for example using a verification identification service such as http://www.safeid.org/. This would automate the process of increasing the security and authenticity of the stored estate documents.

Instead of checking the data entered by the user directly into the database 108, the information received by the system 100 would be organized, time and date stamped by the version control software. These changes would trigger the notification to the designated recipients by the Notification services either through email or text messages. The version control software can be queried to generate a current version of the one or more estate document including all authorized changes.

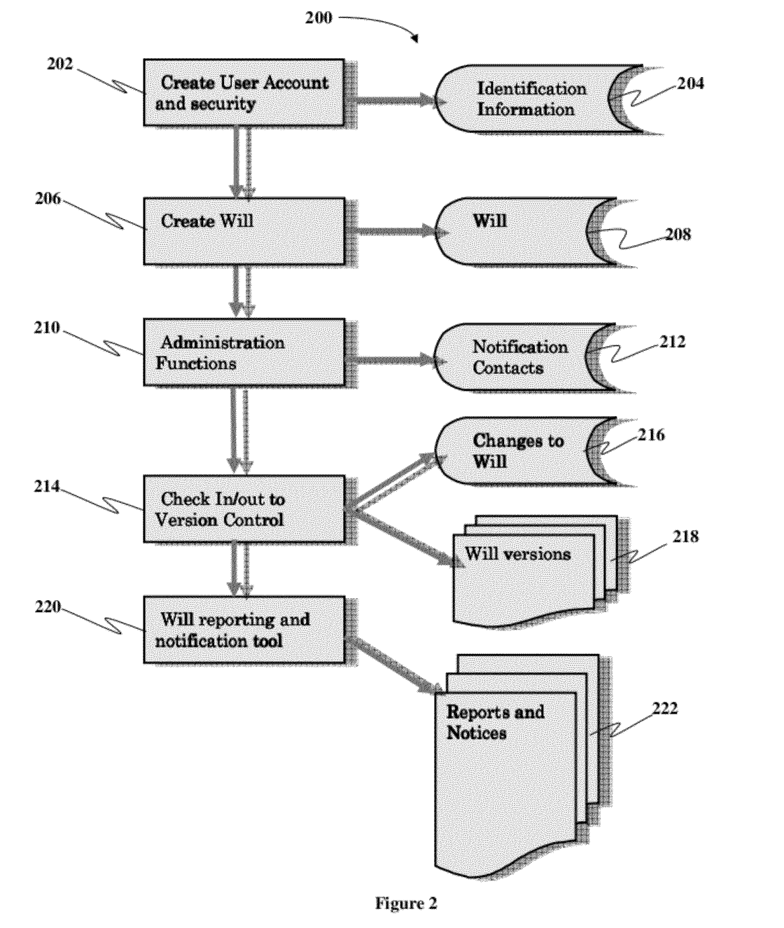

Referring now to FIG. 2, there is shown a flowchart 200 of a method of an online document management system 100 to prevent unauthorized changes in stored documents using easily producible audit trails and timely notifications to all affected parties when changes are made to the stored documents according to one embodiment of the present invention.

Initially, a user of the system 100 must establish an account by requesting the estate document server 106 transmit an account creation form. Then, the account information is received by the estate document server 106 and processed. Next, a security identification is transmitted from the estate document server 106 to the user for future access to the system 100.

The following example describes a method for the creation of a will by a testator as an exemplar of the system 100. As will be understood by those with skill in the art, there are many other possible uses of the system and this exemplar is not intended to limit the invention.

After the account has been established, as detailed above, a user can access the system 100 using the following method 200. First, account information is transmitted 204 to the user. Then, the security identification is confirmed 202. Next, one or more than one estate document form is transmitted 206 to the user. Then, the one or more than one estate document form is received by the one or more than one estate document server 106. Next, the one or more than one estate document is verified for completeness and security. Then, if this is the first version of the one or more than one estate document, the document is stored in the database 108. If the user is making an alteration to the one or more than one estate document, the latest version of the one or more than one estate document is retrieved from the database 108. Next, changes to the one or more than one estate document are received by the one or more than one estate document server 106. Then, the user is authenticated. Next, the security identification, a time and date stamp, and other estate document indicia, such as, for example, designated recipients, are added to the one or more than one estate document. Then, a new version of the one or more than one estate document is stored in the database 108 without destroying any previous versions of the one or more than one estate documents. Next, notifications of the change to the one or more than one estate document are sent to designated recipients. Finally, the system 100 can transmit complete audit trails, sent notifications, and one or more than one estate document versions upon receipt of a request from an authorized user of the account. Authorized users can include legal, court and law enforcement representatives that have previously been designated, automatically, or with the proper court order for access to the account.

What has been described is a new and improved system and method for an online estate document management system to prevent unauthorized changes in stored estate documents using easily producible audit trails and timely notifications to all affected parties when changes are made to the stored estate documents.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A system for online estate document management, the system comprising:
a) a user interface;
b) one or more than one estate document servers operably connected to the user interface;
c) an estate document database operably connected to the one or more than one estate document servers;
d) instructions for verifying the user;
e) instructions for version control of the one or more than one estate document; and
f) instructions for notifying one or more than one recipient of changes to the one or more than one estate document.

2. The system of claim 1, where the user interface comprises instructions for entering one or more than one estate document, creating one or more than one estate document or both creating and entering one or more than one estate document.

3. The system of claim 1, where the database comprises the current version of the one or more than one estate document.

4. The system of claim 1, where the database comprises every previous version of the one or more than one estate document.

5. The system of claim 1, where the one or more than one estate document servers further comprise instructions for encrypting the one or more than one estate documents.

6. A method for using an online estate document management, the method comprising the steps of:
a) providing the system of claim 1;
b) transmitting account information is transmitted to a user;
c) confirming the security identification;
d) transmitting the latest version of one or more than one estate document to the user;
e) receiving the one or more than one estate document from the user;
f) verifying the one or more than one estate document for completeness and security;
g) modifying the one or more than one estate document by adding the security identification, a time and date stamp, and other estate document indicia to the one or more than one estate document;
h) storing the modified version of the one or more than one estate document the database without destroying any previous versions of the one or more than one estate documents; and
i) sending notifications of the change to the one or more than one estate document to designated recipients.

7. The method of claim 6, further comprising the step of storing a first version of the one or more than one estate document in the database.

8. The method of claim 6, further comprising the step of transmitting complete audit trails, sent notifications, and one or more than one estate document versions upon receipt of a request from an authorized user of the account.

9. The method of claim 6, further comprising the steps for initially creating an account, the steps comprising:
a) transmitting an account creation form upon request from a user;
b) receiving account information by the estate document server;
c) processing the account information;
d) transmitting a security identification from the estate document server to the user for future access to the system.
